(19) United States
(12) Patent Application Publication
(10) Pub. No.: US 2011/0045394 A1
(43) Pub. Date: Feb. 24, 2011

(54) TONER SET AND IMAGE FORMING METHOD

(75) Inventors: Noriyuki MIZUTANI, Kanagawa (JP); Shinichi YAOI, Kanagawa (JP); Yasushige NAKAMURA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD, TOKYO (JP)

(21) Appl. No.: 12/704,178

(22) Filed: Feb. 11, 2010

(30) Foreign Application Priority Data
Aug. 21, 2009 (JP) 2009-191686

(51) Int. Cl. G03G 9/09; G03G 9/08; G03G 9/087; G03G 13/20

(52) U.S. Cl. 430/107.1; 430/105; 430/109.1; 430/124.4

(57) ABSTRACT

An electrostatic image developing toner set includes two or more toners different in hue, wherein a difference between maximum and minimum values of an absorption rate α in a range of from 380 nm to 1,500 nm of each of the two or more toners is about 0.1 or less, the absorption rate α being represented by the following equation (1):

$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$

wherein e_{λ} represents an emission intensity of a light source at a wavelength λ, and A_{λ} represents an absorbance of a toner at a wavelength λ.

### CROSS-REFERENCE TO RELATED APPLICATIONS

This application is based on and claims priority under 35 USC 119 from Japanese Patent Application No. 2009-191686 filed on Aug. 21, 2009.

### BACKGROUND

1. Technical Field

The present invention relates to a toner set and an image forming method using the toner set.

2. Related Art

In electrophotography, an image is formed by attaching a toner contained in a developer to an electrostatic latent image fanned on a photoconductive insulator to form a toner image, transferring the toner image to a recording medium such as paper or plastic film, and then fixing the image. Methods for fixing the toner image which has been transferred to the recording medium but has not yet been fixed can be classified roughly into contact fixing system and non-contact fixing system.

The contact fixing system includes a pressure fixing system in which pressure is applied at normal temperature by using a pressure roll and a heat roll system using a heat roll. The non-contact fixing system includes oven fixing by heating in an oven, flash fixing with a xenon lamp, electromagnetic wave fixing with microwaves or the like, and solvent fixing by using the vapor of a solvent. Of these, flash fixing with a xenon lamp and laser fixing with a laser light are non-contact fixing methods using a photothermal conversion action that converts light energy to heat energy and are advantageous because they permit high-speed fixing, do not produce a standby energy loss, and do not cause a paper jam problem which will otherwise occur in the non-contact system.

### SUMMARY

According to an aspect of the invention, there is provided an electrostatic image developing toner set including two or more toners different in hue, wherein a difference between maximum and minimum values of an absorption rate α in a range of from 380 nm to 1,500 nm of each of the two or more toners is about 0.1 or less, the absorption rate α being represented by the following equation (1):

$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$

wherein e_{λ} represents an emission intensity of a light source at a wavelength λ, and A_{λ} represents an absorbance of a toner at a wavelength λ.

### BRIEF DESCRIPTION OF THE DRAWINGS

Exemplary embodiment(s) of the present invention will be described in detail based on the following figures, wherein:

FIG. 1 illustrates one example of a spectral energy distribution of a xenon lamp light source usable in the exemplary embodiment; and

FIG. 2 illustrates an example of the absorbance of respective toners constituting a CMYK toner set, wherein Y represents a yellow toner, M represents a magenta toner, C represents a cyan toner, and K represents a black toner.

### DETAILED DESCRIPTION

The toner set according to the exemplary embodiment is an electrostatic image developing toner set composed of two or more toners different in hue and it is characterized in that a difference between the maximum value and minimum value of an absorption rate α of each of the toners at a wavelength range from 380 to 1,500 nm is 0.1 (10%) or less, or about 0.1 (10%) or less.

$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$

wherein, e_{λ} represents an emission intensity of a light source at a wavelength λ and A_{λ} represents an absorbance of a toner at a wavelength λ.

Although the above-described toner set can be employed without a problem in heat drum fixing, it is preferably employed in so-called flash fixing. The term “flash fixing” as used herein means a method of exposing a recording medium (such as paper or PET film) having an unfixed toner image to a light source uniformly or performing scanning exposure of it to a laser light, heating it with a heat energy converted from a light energy in the toner image which has absorbed the light energy, and thereby fixing the toner image to the recording medium. The flash fixing is a non-contact type fixing system.

As the light source to be used for the above-described flash fixing, xenon flash light source and semiconductor laser (emission wavelength: about 800 nm) are preferred as described later.

The present inventors have found that a difference in fixing property between two or more toners when they are exposed to the same light can be explained by a difference in absorption rate α defined by the above equation (1).

The absorption rate α defined by the equation (1) indicates how much energy of an incident light is absorbed by a toner and it can be determined from a ratio between an energy, which is obtained by accumulating the products of an energy of an incident light and an absorbance at each wavelength, and a total energy of the incident lights. It is presumed to be a rate of a light energy absorbed by the toner in practice.

The heating value generated by the photothermal conversion is proportionate to an absorbed light energy so that by decreasing a difference (Δα) in absorption rate α between two toners different in hue and one having a maximum absorption rate and the other having a minimum absorption rate, the heating values of the toners are brought close to each other to control the fixing property.

The absorption rate α is a rate so that an energy of an incident light can be determined if a relative intensity of an irradiation light source at each wavelength can be measured. It is not necessary to measure it as an absolute value. In most cases, a xenon lamp or a laser light provides a high energy output as a light source used for fixing through photothermal conversion so that even if a direct energy cannot be measured, it is possible to determine the absorption rate α and the difference (Δα) in absorption rate α in the exemplary embodiment by measuring a relative intensity after attenuating by using a filter or the like.

In the exemplary embodiment, Δα is 0.1 or less, or about 0.1 or less, preferably from 0.02 to 0.10 or from about 0.02 to about 0.10.

The toner set according to the exemplary embodiment is used in an image forming method in which fixing is performed using non-contact thermal fixing based on photothermal conversion and it is composed of two or more toners different in hue. This electrostatic image developing toner set contains preferably at least a black toner, more preferably a black toner using carbon black as a black pigment and at least one color toner. The toner set is especially preferably a full-color reproduction toner set composed of a black toner containing carbon black and toners of three primary colors (CMY). It may be a toner set composed of front five to seven color toners including special-color ones such as orange, green, and violet.

When the black toner contains carbon black as a coloring agent, the absorption rate α of it is likely to be greater than that of a color toner. The absorption rate α of a toner of any hue is preferably 0.7 or greater, or about 0.7 or greater, more preferably 0.8 or greater, or about 0.8 or greater. It is still more preferred to incorporate at least one infrared absorbing material in a color toner having a low absorption rate α, thereby adjusting the absorption rate α of the color toner to 0.7 or greater, or about 0.7 or greater, more preferably 0.8 or greater, or about 0.8 or greater.

In the exemplary embodiment, a difference in absorption rate α between any two toners constituting the toner set is required to be 0.1 (10%) or less, or about 0.1 (10%) or less, preferably 0.08 (8%) or less, or about 0.08 (8%) or less, more preferably 0.07 (7%) or less, or about 0.07 (7%) or less. When a difference in absorption rate between any two toners exceeds 10%, they tend to vary in fixing property. In such a case, in particular, a portion of the toner may remain unfixed in a halftone image or image quality defects due to voids may occur in a solid image.

The wavelength range upon determination of the absorption rate α is from 380 nm to 1,500 nm. On the longer wavelength side exceeding 1,500 nm, an energy is small so that it does not contribute to fixing even if absorption is large. On the other hand, an ultraviolet range with a wavelength less than 380 nm is advantageous for fixing because an energy is high, but it is used rarely for a light source for fixing through photothermal conversion because it may cause decomposition fading of a resin or color material.

In the exemplary embodiment, the absorption rate α depends on both the emission spectrum of a light source (wavelength dependence of emission intensity) and absorption spectrum of the toner itself (wavelength dependence of absorbance). The absorption rate α can therefore be controlled both on the side of the light source and on the side of the toner. As the control on the light source side, it is desired to select a light source having a strong emission spectrum for a wavelength of the toner having a high absorbance. It is however difficult to change the emission spectrum in light sources other than some semiconductor lasers whose wavelength can be changed so that in practice, it is preferred to control the absorption rate α by changing the absorption spectrum of the toner.

The absorption spectrum of a toner can be controlled by incorporating an infrared absorbing material in the toner.

Particularly, it is preferred to incorporate an infrared absorbing material in color toners such as cyan toner, magenta toner, and yellow toner to raise their absorption rate α.

As the infrared absorbing material to be used in the exemplary embodiment, those having a strong absorption (absorption maximum) at a wavelength from 780 nm to 1,200 nm are preferred from the standpoint of adaptability to a light source emitting infrared rays at a high output power.

Such infrared absorbing materials can be selected from known ones. The infrared absorbing materials are preferably compounds having almost no absorption in a visible range (from 380 nm to 780 nm) and having a strong absorption in a wavelength range of from 780 nm to 1,200 nm. Examples of the infrared absorbing material include aminium compounds, diimmonium compounds, naphthalocyanine compounds, anthraquinone compounds, polymethine compounds, cyanine compounds, merocyanine compounds, squarylium compounds, and nickel complex compounds. The absorption rate α can be controlled by using, either singly or in combination, infrared absorbing materials having a strong absorption in a wavelength range of the emission spectrum of a light source to be used. In the exemplary embodiment, since absorption not only in an infrared region but also in a visible region has an influence so that light absorption, in a visible region and an infrared region, of a pigment itself to be used ordinarily as a coloring material has an influence on photothermal conversion properties.

Specific examples of the infrared absorbing materials include cyanine-based infrared absorbing materials (“IRF-106” and “IRF-107”, each trade name: product of Fuji Photo Film, “YKR2900”, trade name, product of Yamamoto Chemicals), diimmonium-based infrared absorbing materials (“NIR-AM1”, and “NIR-IM1”, each, trade name; product of Nagase ChemteX, “IRG-022” and “IRG-023”, each trade name; product of Nippon Kayaku), immonium compounds (“CIR-1080” and “OR-1081”, each, trade name; product of Japan Carlit), aminium compounds (“CIR-960” and “OR-961”, each, trade name; product of Japan Carlit, “IRG-002”, “IRG-003”, and “IRG-003K, each, trade name; product of Nippon Kayaku), anthraquinone compounds (“IRG-750”, trade name; product of Nippon Kayaku), polymethine compounds (“IR-820B”, trade name; product of Nippon Kayaku), nickel metal complex-based infrared absorbing materials (“SIR-130” and “SIR-132”, each, trade name; product of Mitsui Chemicals), bis(dithiobenzyl)nickel (“MIR-101”, trade name, product of Midori Kagaku), bis[1,2-bis(p-methoxyphenyl)-1,2-ethylenedithiolate]nickel (“MIR-102”, trade name, product of Midori Kagaku), tetra-n-butylammoniumbis(cis-1,2-diphenyl-1,2-ethylenedithiolate)nickel (“MIR-1011”, trade name, product of Midori Kagaku), tetra-n-butylammoniumbis[1,2-bis(p-methoxyphenyl)-1,2-ethylenedithiolate]nickel (“MIR-1021”, trade name, product of Midori Kagaku), bis(4-tert-1,2-butyl-1,2-dithiophenolate)nickel-tetra-n-butylammonium (“BBDT-NI”, trade name; product of Sumitomo Seika Chemicals), dianine compounds (“CY-2”, “CY-4”, and “CY-9”, each, trade name; product of Nippon Kayaku), soluble phthalocyanine (“TX-305A”, trade name; product of NIPPON SHOKUBAI), naphthalocyanines (“YKR5010”, trade name; product of YAMAMOTO CHEMICALS, “Sample 1”, product of Sanyo Color Works), inorganic materials (“Ytterbium UU-HP”, trade name; product of Shin-Etsu Chemical and indium tin oxide, product of Sumitomo Metal Industries), and squarylium compounds. Of these, diimmonium-, aminium-, naphthalocyanine-, and cyanine-based infrared absorbing materials are preferred, with diimmonium-, aminium-, and naphthalocyanine-based infrared absorbing materials being more preferred.

The effect in the exemplary embodiment can be considered as follows.

Flash fixing or laser fixing is advantageous because it is non-contact and high-speed fixing. When toners different in photothermal conversion efficiency are fixed simultaneously, however, the above-described non-contact heat fixing system utilizing photothermal conversion has such a problem as difference in fixing property between the toners. This phenomenon is particularly marked between a black toner and a color toner. A black toner using carbon black as a coloring agent shows high absorbance in a wide wavelength range from visible light to infrared light and its absorbance becomes higher than that of a color toner using an organic pigment as a coloring agent. As a result, there appears a difference in an energy amount necessary for fixing between a black toner and a color toner, leading to occurrence of an inconvenience as described below. Described specifically, when an energy necessary for a black toner is given for fixing of a solid image, a color toner cannot be fixed sufficiently. On the other hand, when an energy necessary for a color toner is given, it causes a severe increase in the temperature of the black toner, resulting in burning of paper or occurrence of so-called voids, that is, an image surface defect due to evaporation of water contained in the toner or paper.

In addition, in a halftone image, toner particles are separated from each other and an aggregation force between the toner particles does not act easily, leading to appearance of such a marked difference in fixing property.

In the exemplary embodiment, a difference in a flash fixing behavior among respective toners in a toner set including a black toner and two or more toners different in color hue is minimized by controlling a difference (Δα) between the maximum and minimum absorption rates α of each toner to from 380 nm to 1,500 nm.

### <Electrostatic-Image-Developing Toner>

The electrostatic-image-developing toner (which may hereinafter be called “toner”) usable in the exemplary embodiment will next be described totally. No particular limitation is imposed on the toner insofar as it satisfies the requirement for the difference (Δα) between the maximum and minimum absorption rates α represented by the above equation (1). Known toner components are therefore usable and examples of them include coloring toners having a binder resin and a coloring agent.

### (Toner Particles)

The toner particles of the toner usable in the exemplary embodiment contain a binder resin and a coloring agent and they contain preferably a release agent, silica, and a charge controlling agent, as needed.

Examples of the binder resin include homo- or copolymers of styrene or a derivative thereof such as chlorostyrene, a monoolefin such as ethylene, propylene, butylene, or isoprene, a vinyl ester such as vinyl acetate, vinyl propionate, vinyl benzoate, or vinyl butyrate, an α-methylene aliphatic monocarboxylic acid ester such as methyl acrylate, ethyl acrylate, butyl acrylate, dodecyl acrylate, octyl acrylate, phenyl acrylate, methyl methacrylate, ethyl methacrylate, butyl methacrylate, or dodecyl methacrylate, a vinyl ether such as vinyl methyl ether, vinyl ethyl ether, or vinyl butyl ether, or a vinyl ketone such as vinyl methyl ketone, vinyl hexyl ketone, or vinyl isopropenyl ketone. Of these, polystyrene, styrene-alkyl acrylate copolymers, styrene-alkyl methacrylate copolymers, a styrene-acrylonitrile copolymer, a styrene-butadiene copolymer, a styrene-maleic anhydride copolymer, polyethylene, and polypropylene are typical binder resins. Additional examples include polyester, polyurethane, epoxy resins, silicone resins, polyamide, modified rosin, and paraffin wax. Of these, styrene-alkyl acrylate copolymers, styrene-alkyl methacrylate copolymers, and polyester resins are especially preferred.

Amorphous resins are usable as the binder resin for the toner but not only them but also crystalline resins may be used as needed. No particular limitation is imposed on them insofar as they have crystallinity. Specific examples include crystalline polyester resins and crystalline vinyl resins. From the standpoint of adhesion or charging property to paper upon fixing thereto and adjustability of a melting temperature within a preferred range, crystalline polyester resins are preferred. Of these, aliphatic crystalline polyester resins having an adequate melting temperature are more preferred.

### <Coloring Agent>

Although no particular limitation is imposed on the coloring agent usable in the exemplary embodiment, known coloring agents are usable and a proper one can be selected from them, depending on its using purpose. These coloring agents may be used singly or two or more of these coloring agents similar in color may be used as a mixture. Alternatively, two or more of these coloring agents different in color may be used as a mixture. Further, these coloring agents may be provided for use after surface treatment.

Coloring toners can be classified roughly into a black toner and a color toner. The black toner is a toner that produces a black color and carbon black is used preferably as a coloring agent for it. The color toner is a toner producing a color other than a black color. A combination of three primary colors composed of a yellow toner, a magenta toner, and a cyan toner is preferably used for reproduction of a full color.

Examples of the coloring agent for a coloring toner include magnetic powders such as magnetite and ferrite; various pigments such as carbon black, lamp black, chromium yellow, Hanza Yellow, Benzidine Yellow, Threne Yellow, Quinoline Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Rose Bengal, Aniline Blue, Ultramarine Blue, Calco Oil Blue, Ultramarine Blue, Methylene Blue Chloride, Phthalocyanine Blue, Phthalocyanine Green, and Malachite Green Oxalate; and various dyes such as acridine dyes, xanthene dyes, azo dyes, benzoquinone dyes, azine dyes, anthraquinone dyes, thioindigo dyes, dioxazine dyes, thiazin dyes, azomethine dyes, indigo dyes, thioindigo dyes, phthalocyanine dyes, aniline black dyes, polymethine dyes, triphenylmethane dyes, diphenylmethane dyes, thiazine dyes, thiazole dyes, and xanthene dyes. These coloring agents may be used either singly or in combination.

In addition, C.I. Pigment Red 48:1, C.I. Pigment Red 122, C.I. Pigment Red 57:1, C.I. Pigment Yellow 97, C.I. Pigment Yellow 17, C.I. Pigment Blue 15:1, and C.I. Pigment Blue 15:3 and the like are preferred.

The content of the coloring agent is preferably within a range of from 1 part by mass to 30 parts by mass or from about 1 part by mass to about 30 parts by mass based on 100 parts by mass of the binder resin of the toner. Using a surface-treated coloring agent or a pigment dispersant when necessary is also effective. A yellow toner, a magenta toner, a cyan toner, or a black toner can be obtained by selecting a proper coloring agent therefor.

If necessary, a release agent or a charge controlling agent may be incorporated in the toner.

Examples of the release agent include low-molecular weight polyolefins such as polyethylene, polypropylene, and polybutene; silicones that soften under heat; fatty acid amides such as oleic amide, erucic amide, recinoleic amide, and stearic amide; plant waxes such as ester wax, carnauba wax, rice wax, candelilla wax, Japan tallow, and jojoba oil; animal waxes such as bees wax; mineral waxes such as montan wax, ozokerite, ceresin, paraffin wax, microcrystalline wax, and Fischer-Tropsch wax; petroleum waxes; and modified products thereof.

The amount of the release agent is preferably within a range of 50 wt. % or less, or about 50 wt. % or less based on the total amount of the toner.

As the charge controlling agent, known ones are usable. For example, azo-based metal complex compounds, metal complex compounds of salicylic acid, and resin types containing a polar group can be used as the charge controlling agent. When the toner is prepared by using a wet process, materials not easily soluble in water are preferred from the standpoint of control of ion intensity and reduction of waste water contamination. The toner according to the exemplary embodiment may be either a magnetic toner enclosing a magnetic material therein or a non-magnetic toner not containing a magnetic material.

The toner particles can be produced, for example, by the kneading and grinding method in which the binder resin and the coloring agent, and if necessary, the release agent, the charge controlling agent, and the like are kneaded, ground, and classified; the method of changing, with a mechanical impact power or heat energy, the shape of particles obtained by the kneading and grinding method: the emulsion polymerization aggregation method in which a dispersion obtained by emulsion polymerization of a polymerizable monomer of the binder resin is mixed with the coloring agent and if necessary a dispersion of the release agent, the charge controlling agent, and the like, followed by aggregation and thermal fusion bonding; the suspension polymerization method in which polymerization is performed by suspending a polymerizable monomer to obtain the binder resin and a solution of the coloring agent, and if necessary, the release agent, the charge control agent, and the like in an aqueous solvent; or the dissolution suspension method in which the binder resin and a solution of the coloring agent and if necessary, the release agent, the charge controlling agent, and the like are suspended in an aqueous solvent and the resulting suspension is granulated. Toner particles having a core-shell structure may be produced by using the toner particles obtained by any of the above-described methods as a core, attaching thereto aggregated particles, and fusing them by heating.

The toner particles thus produced have a volume-average particle size of preferably from 2 μm to 8 μm, more preferably from 3 μm to 7 μm. The toner particles having a volume-average particle size of 2 μm or greater are preferred because they have high fluidity and in addition, they are imparted with sufficient chargeability from the carrier so that they do not easily cause fog on the background or deterioration in density reproduction. The toner particles having a volume-average particle size not greater than 8 μm are, on the other hand, preferred, because they are effective for improving the reproducibility of fine dots, gradation characteristics, and graininess and can therefore provide a high quality image.

Accordingly, when the toner has a volume-average particle size within the above range, faithful reproduction of fine latent-image dots can be expected even in repeated copying of an original having a large image area and a density gradation such as photographs, pictures, or brochures.

### (Magnetic Material)

The toner according to the exemplary embodiment may contain a magnetic material if necessary.

Examples of the magnetic material include a metal or alloy exhibiting a ferromagnetic property, such as iron, cobalt and nickel, including ferrite and magnetite; a compound containing such an element; an alloy containing no ferromagnetic element but caused to exhibit a ferromagnetic property when subjected to an appropriate heat treatment, for example, an alloy of the type called Whisler alloy containing manganese and copper, such as manganese-copper-aluminum and manganese-copper-tin; and chromium dioxide. For example, in the case of obtaining a black toner, magnetite which is black itself and exerts a function as a coloring agent may be especially preferred. In the case of obtaining a color toner, on the other hand, a magnetic material with little blackish tint, such as metallic iron, is preferred. Some of these magnetic materials function as a coloring agent and in such a case, the magnetic material may be used to serve also as the coloring agent. The content of such a magnetic material is, in order to obtain a magnetic toner, preferably from 20 parts by weight to 70 parts by weight, more preferably from 40 parts by weight to 70 parts by weight, based on 100 parts by weight of the toner.

### (Internal Additive)

The toner according to the exemplary embodiment may contain an internal additive therein. The internal additive is generally used for the purpose of controlling viscoelasticity of the fixed image.

Specific examples of the internal additive include inorganic particles such as silica and titania and an organic particles such as polymethyl methacrylate. The internal additive may be surface-treated for enhancing the dispersibility. These internal additives may be used either singly or in combination.

### (External Additive)

The toner according to the exemplary embodiment may be subjected to addition treatment with an external additive such as fluidizing agent and charge controlling agent.

Known materials can be used as the external additive. Examples include inorganic particles such as silica particles surface-treated with a silane coupling agent or the like, titanium oxide particles, alumina particles, cerium oxide particles, and carbon black, polymer particles such as polycarbonate, polymethyl methacrylate, and silicone resin, amine metal salts, and salicylic acid metal complexes. These external additives usable in the exemplary embodiment may be used either singly or in combination.

### <Image Forming Method>

### (Image Forming Method Employing Non-Contact Fixing)

The image forming method according to the exemplary embodiment is characterized in that it includes a step of preparing a toner set which contains two or more toners different in hue and in which a difference between the maximum absorption rate α and minimum absorption rate α of each toner in a wavelength range of from 380 nm to 1,500 nm and represented by the equation (1) is 0.1 or less; a step of forming a toner image by using the toners different in hue; and a step of fixing the toner image by non-contact fixing.

$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$

wherein, e_{λ} represents an emission intensity of a light source at a wavelength λ and A_{λ} represents an absorbance of a toner at a wavelength λ.

It is preferred that in the step of forming a toner image in the above-described image forming method, the color toners each has an absorption rate α of 0.7 or greater.

It is also preferred that the above-described non-contact fixing step is executed using flash exposure with a xenon lamp or scanning exposure with a semiconductor laser.

Further, in the non-contact fixing step, the process speed is preferably 1,000 mm/sec or greater, or about 1,000 mm/sec or greater. Although no upper limit is imposed on the process speed, a process speed not greater than 3,000 mm/sec is suited for practical use.

The preferred exemplary embodiment will next be described in detail.

The image forming method according to the exemplary embodiment includes a step of forming an electrostatic latent image on the surface of an image holding member, a step of developing, with a toner or a developer containing the toner, the electrostatic latent image formed on the surface of the image holding member to fowl a toner image, a step of transferring the toner image formed on the surface of the image holding member to the surface of a transfer-receiving material, and a step of fixing the toner image transferred to the surface of the transfer-receiving material, wherein a non-contact fixing system is employed in the fixing step.

The latent-image forming step, the developing step, and the transfer step may also be called “a step of forming a toner image”, collectively. The term “step of forming a toner image with two or more toners different in hue” means a step of repeating a series of the latent-image forming step, the developing step, and the transfer step times corresponding to the number of the toners and thereby forming, with two or more toners different in hue, a stack of toner images in which toner images of respective colors have been overlapped one after another.

The toner images of respective colors are fixed simultaneously by non-contact fixing.

The electrostatic latent image forming step is a step of uniformly charging the surface of a latent image holding member by using a charging unit and exposing the image holding member with a laser optical system or an LED array to form an electrostatic latent image. Examples of the charging unit include non-contact-type charging devices such as corotron and scorotron and contact type charging devices that charge the surface of the latent image holding member by applying a voltage to a conductive member brought into contact with the surface of the image holding member. Any one of these charging devices may be used, but contact type charging devices are preferred because they generate only a small amount of ozone, are eco-friendly, and bring about excellent printing durability. In the contact type charging devices, the shape of the conductive member may be any one of a brush, blade, pin electrode, roller, and the like, but a member of a roller shape is preferred. The image forming method according to the exemplary embodiment is not limited particularly with respect to its latent image fowling step.

The developing step is a step of bringing a developing agent holding member having, on the surface thereof, a developing agent layer containing at least a toner into contact with or close to the surface of the image holding member to make toner particles adhere to the electrostatic latent image on the surface of the image holding member to form a toner image on the surface of the image holding member. Known systems may be used in the developing system, and examples of a developing system with a two-component developing agent which can be employed in the exemplary embodiment include a cascade system and a magnetic brush system. The image forming method according to the exemplary embodiment is not limited particularly with respect to its developing system.

The transfer step is a step of directly transferring the toner image formed on the surface of the image holding member to a recording medium or transferring the toner image to an intermediate transfer receiving material and then transferring the image to another transfer receiving material to form a transferred image.

A corotron may be used as a device for transferring the toner image from the image holding member on paper or the like. Although the corotron is effective as a unit for uniformly charging paper, a voltage as high as several kV should be applied in order to give a predetermined charge to paper as a transfer receiving material. It needs a high-voltage power source. Furthermore, ozone produced by corona discharge deteriorates rubber parts or the image holding member so that it is preferred to employ a contact transfer system in which a conductive transfer roll made of an elastic material is brought into contact with the image holding member under pressure to transfer the toner image onto paper. The image forming method according to the exemplary embodiment is not particularly limited with respect to the transfer device.

The fixing step is a step of fixing the toner image, which has been transferred to the surface of the recording medium, by using a fixing device. In the exemplary embodiment, it is preferred to employ a non-contact fixing step instead of a fixing step with a heat roll.

In the step of forming a toner image in the image forming method, it is preferred that the color toners each has an absorption rate α of 0.7 or greater, or about 0.7 or greater. In the formation of a full color image, all the color toners, that is, the cyan toner, the magenta toner, and the yellow toner each has an absorption rate α of preferably 0.7 or greater, or about 0.7 or greater, more preferably 0.8 or greater, or about 0.8 or greater. When the toner set contains a special-color toner other than these CMY toners, the special-color toner has an absorption rate α of preferably 0.7 or greater, or about 0.7 or greater, more preferably 0.8 or greater, or about 0.8 or greater.

In the exemplary embodiment, no particular limitation is imposed on the light source to be used for non-contact fixing and a xenon lamp (including a flash lamp) and a semiconductor laser are preferred. As the semiconductor laser, that having an emission wavelength of approximately 800 nm is preferred. A combination of a plurality of such light sources is used as a necessary irradiation energy. A combination of light sources different in kind such as a combination of a xenon lamp and a semiconductor laser may be used to achieve a necessary spectral energy distribution and irradiation energy.

An adequate irradiation energy can be obtained by arranging five semiconductor laser (center wavelength: 808 nm) oscillators in an array, stacking the array one after another, and forming a linear beam by using a collimation lens.

The irradiation energy at the time of fixing is preferably from 1 J/cm² to 10 J/cm², more preferably from 1.5 J/cm² to 5 J/cm².

When a full-color image is created in the image forming method according to the exemplary embodiment, it is preferred that by a series of steps comprised of a latent image forming step with a plurality of image holding members and a plurality of developer holding members of respective colors which the image holding members have, a developing step, a transfer step, and a cleaning step, toner images of the respective colors are stacked successively and the full-color toner image obtained thereby is thermally fixed in a fixing step. Using the electrophotographic developer enables to achieve stable development, transfer and fixing performance even in a tandem system suited for down-sized and appropriate for high-speed color printing.

Examples of the transfer receiving material (recording medium) to which a toner image is transferred include plain paper and OHP sheets used in electrophotographic copying machines, printers, and the like. The surface of the transfer receiving material is preferably as smooth as possible in order to improve the smoothness of the surface of the image after fixing. For example, coated paper obtained by coating the surface of plain paper with a resin or the like, art paper for printing, and the like are preferred.

### Examples

The exemplary embodiment will hereinafter be described by examples. It should however be borne in mind that the exemplary embodiment is not limited to these examples. In the examples, all designations of “part” or “parts” and “%” mean part or parts by weight and wt. % unless otherwise specifically indicated.

First, measuring methods of physical properties in the examples will be described.

### —Measurement of Molecular Weight—

The molecular weight distribution is measured under the following conditions. A device “HLC-8120GPC, SC-8020” (trade name; product of Tosoh Corporation) is used; “TSK GEL Super HM-H” (6.0 mm ID×15 cm×2) is used as a column; and THF (tetrahydrofuran) is used as an eluent. The experiment is performed under the conditions of a sample concentration of 0.5%, a flow rate of 0.6 ml/min, a sample injection amount of 10 μl, and a measurement temperature of 40° C. A calibration curve is created from ten samples, that is, A-500, F-1, F-10, F-80, F-380, A-2500, F-4, F-40, F-128, and F-700. In sample analysis, data are collected at intervals of 300 ms.

### —Volume Average Particle Size of Toner—

In measurement of the particle size of a toner, “Coulter Counter TA-II” (trade name; product of Beckman Coulter) is used as a measuring device and “ISOTON-II” (trade name; product of Beckman Coulter) is used as an electrolyte.

As a measuring method, from 0.5 mg to 50 mg of a sample to be measured is added to 2 ml of a 5 wt. % aqueous solution of a surfactant serving as a dispersant, preferably sodium alkylbenzene sulfonate. The resulting mixture is added to from 100 to 150 ml of the electrolyte. The electrolyte having the sample suspended therein is dispersed for about 1 minute by using an ultrasonic dispersing machine. With the Coulter Counter TA-II equipped with an aperture having an aperture diameter of 100 μm, the particle size distribution of particles from 2 μm to 60 μm is measured, and the volumetric average particle size D_{50V} is determined as described above. The number of particles measured is 50,000.

### —Volume Average Particle Size of Resin Particles, Coloring Agent Particles, and the Like—

The volume average particle size of the particles is measured using a laser diffraction/scattering-type particle size distribution measuring instrument (“LS Particle Size Analyzer LS13 320”, trade name; product of BECKMAN COULTER). The particle size distribution of the particles thus measured is divided into particle size ranges (channels) and a cumulative distribution curve is drawn from the side of smaller particles. On the curve, the particle size giving an accumulation of 50% is defined as a volume-average particle size d.

### —Emission Spectrum of Xenon Lamp—

Measuring devices suited for the respective wavelength regions described below are used.

(1) 380 nm to 1,000 mm: “S2000 Fiber Optic Spectrometer” (trade name; product of Ocean Optics)

(2) 1,000 nm to 1,500 nm: “NIR512 Fiber Optic Spectrometer” (trade name; product of Ocean Optics)

The spectrometers (1) and (2) have already been subjected to sensitivity correction with a tungsten halogen light source (“LS-1-CAL-EXT1”, trade name; product of Ocean Optics).

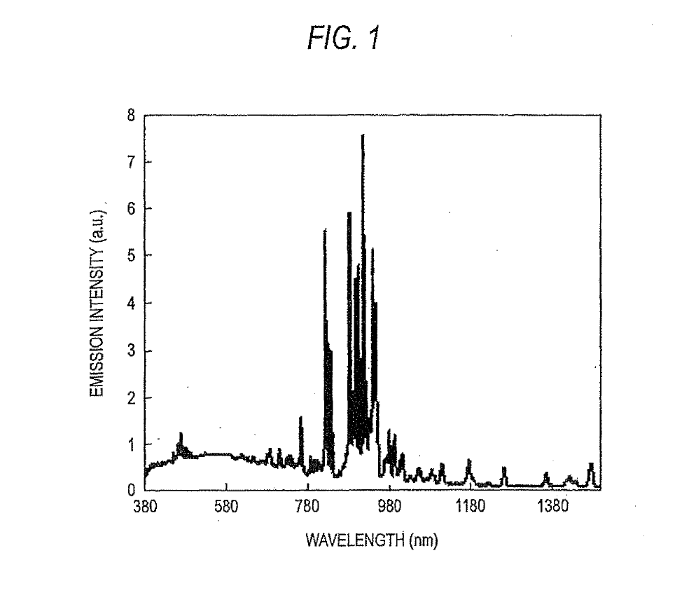

The emission spectrum is measured at a distance of approximately 5 cm from the xenon lamp light source while dimming to 1/1,000 with an ND filter and the wavelength dispersion due to dimming with the ND filter is corrected. The emission spectrum (spectral distribution) thus measured is shown in FIG. 1, in which the wavelength (nm) is plotted on the abscissa and a specific energy is plotted on the ordinate.

### —Absorbance of Toner—

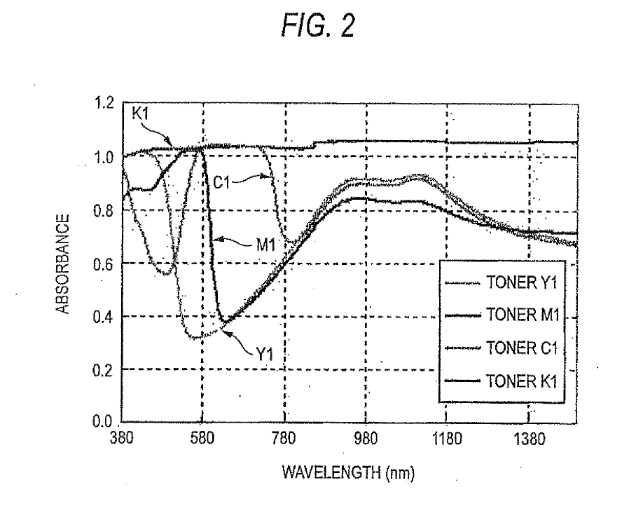

The absorbance is measured at a spectral bandwidth of 1 nm in a wavelength range of from 380 nm to 1,500 nm by using a UN/Vis/NIR spectrophotometer (“V-570”, trade name; product of JASCO Corporation) and filling a quartz cell (10 mm square) with about 5 g of a toner. A typical example of the reflection absorbance spectrum thus obtained is shown in FIG. 2.

### —Preparation of Binder Resin—

(Preparation of polyester resin A and resin particle dispersion A)

| | |
|---|---|
| Dimethyl terephthalate | 155 parts |
| Dimethyl fumarate | 28 parts |
| 2 Mol ethylene oxide adduct of bisphenol A | 157 parts |
| 2 Mol propylene oxide adduct of bisphenol A | 171 parts |

The above-described components are charged in a reaction container equipped with a stirrer, a thermometer, a capacitor, and a nitrogen gas inlet tube. After the reaction container is purged with a dry nitrogen gas, 1.5 parts of dibutyltin oxide is added as a catalyst. In a nitrogen gas stream, the resulting mixture is stirred and reacted at about 195° C. for about 6 hours. After stirring and reacting for about 6 hours at a temperature raised to about 240° C., the pressure in the reaction container is reduced to 10.0 mmHg. Under the reduced pressure, stirring and reaction are performed for 0.5 hour to obtain a yellow transparent polyester resin A.

The polyester resin A thus obtained is dispersed using a high-temperature high-pressure dispersing machine obtained by remodeling “Cavitron CD1010” (trade name; product of Eurotec). At a compositional ratio of 75% of ion exchanged water and 25% of the polyester resin and a pH adjusted to 8.0 with ammonia, Cavitron is operated under the conditions of a rotation speed of a rotor of 60 Hz, a pressure of 5 kg/cm², and heating at 140° C. with a heat exchanger to obtain a polyester resin particle dispersion A having a solid content of 25%. The weight average molecular weight and volume average particle size of the resulting polyester resin particle dispersion are shown in Table 1.

(Preparation of polyester resin B and resin particle dispersion B)

| | |
|---|---|
| Dimethyl terephthalate | 155 parts |
| Dimethyl fumarate | 14 parts |
| Trimellitic anhydride | 19 parts |
| 2 Mol ethylene oxide adduct of bisphenol A | 94 parts |
| 2 Mol propylene oxide adduct of bisphenol A | 239 parts |

The above-described components are charged in a reaction container equipped with a stirrer, a thermometer, a capacitor, and a nitrogen gas inlet tube. After the reaction container is purged with a dry nitrogen gas, 1.2 parts of dibutyltin oxide is added as a catalyst. In a nitrogen gas stream, the resulting mixture is stirred and reacted at about 195° C. for about 6 hours. After stirring and reacting for about 6 hours at a temperature raised to about 240° C., the pressure in the reaction container is reduced to 10.0 mmHg. Under the reduced pressure, stirring and reaction were performed for 0.5 hour to obtain a yellow transparent polyester resin B.

The polyester resin B thus obtained is dispersed using a high-temperature high-pressure dispersing machine obtained by remodeling “Cavitron CD1010” (trade name; product of Eurotec). At a compositional ratio of 75% of ion exchanged water, and 25% of the polyester resin and a pH adjusted to 8.0 with ammonia, Cavitron is operated under the conditions of a rotation speed of a rotor of 60 Hz, a pressure of 5 kg/cm², and heating at 140° C. with a heat exchanger to obtain a polyester resin particle dispersion B having a solid content of 25%. The weight average molecular weight and volume average particle size of the resulting polyester resin particle dispersion are shown in Table 1.

TABLE 1

| | Resin A | Resin B |
|---|---|---|
| Weight average molecular weight | 11,000 | 120,000 |
| | Dispersion A | Dispersion B |
| Volume average particle size | 148 nm | 165 nm |

(Preparation of release agent dispersion)

| | |
|---|---|
| Paraffin wax “HNP9” | 45 parts |
| (trade name, product of Nippon Seiro; melting | |
| temperature: 74° C.) | |
| Anionic surfactant (“Neogen SCK”, trade name; | 5 parts |
| product of Dai-ichi Kogyo Seiyaku) | |
| Ion exchanged water | 200 parts |

After heating the above components to 95° C. and dispersing them by using a homogenizer (“Ultra-turrax T50”, trade name; product of IKA), the resulting dispersion is subjected to dispersion treatment with a high pressure pump model Gaulin homogenizer (product of Gaulin) to prepare a release agent dispersion (concentration of release agent: 20%) having a volume average particle size of 210 nm.

### (Preparation of Additive Dispersion A)

A mixture obtained by mixing 4.843 g (purity: 98%, 30.0 mmol) of 1,8-diaminonaphthalene, 2.85 g (purity: 98%, 32.6 mmol) of cyclopentanone, 8 mg (0.042 mmol) of p-toluenesulfonic acid monohydrate, and 45 ml of toluene is heated while stirring in a nitrogen gas atmosphere. The resulting mixture is reacted for one hour at a temperature of 100° C. or greater but not greater than 110° C., followed by reaction at a temperature of 110° C. or greater but not greater than 118° C. for 2 hours. The reaction product is then refluxed for 2 hours. Water generated during the reaction is removed by azeotropic distillation. After completion of the reaction, toluene is distilled off and a dark brown solid thus obtained is purified by recrystallization from a ethanol-water mixed solvent, followed by drying to obtain 5.70 g (yield: 84.7%) of a perimidine intermediate (a) as a brown solid.

Then, 2.15 g (9.58 mmol) of the resulting perimidine intermediate (a), 456 mg (4M mmol) of 3,4-dihydroxycyclobuta-2-ene-1,2-dione, 20 ml of n-butanol, and 20 ml of toluene are mixed. The resulting mixture is heated while stirring in a nitrogen gas atmosphere and reacted under reflux for 3 hours. Water generated during the reaction is removed by azeotropic distillation. After completion of the reaction, a large portion of the solvent is distilled off in a nitrogen gas atmosphere and the reaction mixture thus obtained is poured in 250 ml of hexane. A blackish brown precipitate thus obtained is collected by suction filtration, washed with hexane, and dried to obtain a blackish brown solid. The resulting solid is extracted from acetone. The extract is separated and purified by high-performance column chromatography (filler: neutral silica gel, developing solvent: a hexane and tetrahydrofuran mixed solvent (volumetric ratio: from 4:1 to 1:1) to obtain 1.50 g (yield: 71.2%) of perimidine-based squarylium pigment as a brown solid. The resulting perimidine-based squarylium pigment has a maximum absorption wavelength λₘₐₓ of 812 nm. Then, 20 parts of the resulting perimidine-based squarylium pigment, 2 parts of an anionic surfactant (“Neogen SC”, trade name; product of Dai-ichi Kogyo Seiyaku), and 80 parts of ion exchanged water are mixed. The resulting mixture is dispersed using a homogenizer (“Ultra-turrax T-50”, trade name; product of MA) at a rotation speed of 5,000 for 5 minutes. Then, the resulting dispersion is defoamed by stirring for 24 hours by using a stirrer. The defoamed dispersion is then dispersed at a pressure of 240 MPa by using a high-pressure impact type dispersing machine “Altimizer HJP30006” (trade name; product of Sugino Machine). Ion exchanged water is added to adjust its solid concentration to 15%. The additive dispersion A thus obtained has a volume average particle size of 0.14 μm.

(Preparation of coloring agent dispersion A)

| | |
|---|---|
| Yellow pigment (“Yellow HG”, trade name; product of | 100 parts |
| Clariant) | |
| Anionic surfactant (“Neogen SC”, trade name; product of | 10 parts |
| Dai-ichi Kogyo Seiyaku) | |
| Ion exchanged water | 900 parts |

After the above components are mixed and dispersed using a homogenizer (“Ultra-turrax T50”, trade name; product of IKA) at a rotation speed of 5,000 for 5 minutes, the resulting dispersion is deaerated by stirring for 24 hours with a stirrer. The dispersion is then dispersed at a pressure of 240 MPa by using a high-pressure impact type dispersing machine “Altimizer HJP30006” (trade name; product of Sugino Machine). Ion exchanged water is added to adjust its solid concentration to 20%. The coloring agent dispersion A thus obtained has a volume average particle size of 0.19 μm.

(Preparation of coloring agent dispersion B)

| | |
|---|---|
| Magenta pigment (C.I. Pigment Red 122, product of | 100 parts |
| Dainichiseika Color & Chemicals) | |
| Anionic surfactant (“Neogen SC”, trade name; product of | 10 parts |
| Daiichi Kogyo Seiyaku) | |
| Ion exchanged water | 900 parts |

After the above components are mixed and dispersed using a homogenizer (“Ultra-turrax T50”, trade name; product of IKA) at a rotation speed of 5,000 for 5 minutes, the resulting dispersion is deaerated by stirring for 24 hours with a stirrer. The dispersion is then dispersed at a pressure of 240 MPa by using a high-pressure impact type dispersing machine “Altimizer HJP30006” (trade name; product of Sugino Machine). Ion exchanged water is added to adjust its solid concentration to 20%. The coloring agent dispersion B thus obtained has a volume average particle size of 0.18 μm.

(Preparation of coloring agent dispersion C)

| | |
|---|---|
| Magenta pigment (C.I. Pigment Red 238, product of | 100 parts |
| Sanyo Color Works) | |
| Anionic surfactant (“Neogen SC”, trade name; product of | 10 parts |
| Dai-ichi Kogyo Seiyaku) | |
| Ion exchanged water | 900 parts |

After the above components are mixed and dispersed using a homogenizer (“Ultra-turrax T50”, trade name; product of IKA) at a rotation speed of 5,000 for 5 minutes, the resulting dispersion is deaerated by stirring for 24 hours with a stirrer. The dispersion is then dispersed at a pressure of 240 MPa by using a high-pressure impact type dispersing machine “Altimizer HJP30006” (trade name; product of Sugino Machine). Ion exchanged water is added to adjust its solid concentration to 20%. The coloring agent dispersion C thus obtained has a volume average particle size of 0.20 μm.

(Preparation of coloring agent dispersion D)

| | |
|---|---|
| Cyan pigment (“ECB-301” trade name; product of | 100 parts |
| Dainichiseika Color & Chemicals) | |
| Anionic surfactant (“Neogen SC”, trade name; product of | 10 parts |
| Dai-ichi Kogyo Seiyaku) | |
| Ion exchanged water | 900 parts |

After the above components are mixed and dispersed using a homogenizer (“Ultra-turrax T50”, trade name; product of IKA) at a rotation speed of 5,000 for 5 minutes, the resulting dispersion is deaerated by stirring for 24 hours with a stirrer. The dispersion is then dispersed at a pressure of 240 MPa by using a high-pressure impact type dispersing machine “Altimizer HJP30006” (trade name; product of Sugino Machine). Ion exchanged water is added to adjust its solid concentration to 23%. The coloring agent dispersion D thus obtained has a volume average particle size of 0.15 μm.

(Preparation of coloring agent dispersion E)

| | |
|---|---|
| Carbon black (“#25”, trade name; product of | 100 parts |
| Mitsubishi Chemical) | |
| Nonionic surfactant (“Nonipol 400”, trade name; product of | 10 parts |
| Sanyo Chemical) | |
| Ion exchanged water | 390 parts |

After the above components are mixed and dissolved, the resulting solution is dispersed for 30 minutes by using a homogenizer (“Ultra-turrax T50”, trade name; product of IKA) to prepare a coloring agent dispersion E in which carbon black has been dispersed as a coloring agent. The resulting coloring agent dispersion E has a volume average particle size of 0.20 μm and a solid content concentration of 20%.

(Preparation of toner Y1)

| | |
|---|---|
| Polyester resin A | 35.2 parts |
| Polyester resin B | 52.8 parts |
| “Paraffin wax HNP9” (trade name; product of Nippon | 6.0 parts |
| Seiro, melting temperature: 74° C.) | |
| Yellow pigment (Yellow HG, product of Clariant) | 4.0 parts |
| Aluminum-based infrared absorbing material | 2.0 parts |
| (“NIR-AM1”, trade name; product of Nagase ChemteX) | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner Y1. The volume average particle size of the toner Y1 thus obtained is shown in Table 2.

### (Preparation of Toner Y2)

In a similar manner to that employed in the preparation of the toner Y1 except that 35 parts of the polyester resin A, 52.5 parts of the polyester resin B, and 2.5 parts of an aminium-based infrared absorbing material “NIR-AM1” are used, a toner Y2 is obtained. The volume average particle size of the resulting toner Y2 is shown in Table 2.

### (Preparation of Toner Y3)

In a similar manner to that employed in the preparation of the toner Y1 except that 35.72 parts of the polyester resin A, 53.58 parts of the polyester resin B, and 0.7 part of an aminium-based infrared absorbing material “NIR-AM1” are used, a toner Y3 is obtained. The volume average particle size of the resulting toner Y3 is shown in Table 2.

(Preparation of toner M1)

| | |
|---|---|
| Polyester resin A | 34.6 parts |
| Polyester resin B | 51.9 parts |
| Paraffin wax “HNP9” (trade name; product of Nippon | 6.0 parts |
| Seiro, melting temperature: 74° C.) | |
| Magenta pigment (C.I. Pigment Red 122, product of | 3.0 parts |
| Dainichiseika Color & Chemicals) | |
| Magenta pigment (C.I. Pigment Red 238, product of | 3.0 parts |
| Sanyo Color Works) | |
| Aminium-based infrared absorbing material | 1.5 parts |
| (“NIR-AM1”, trade name; product of Nagase ChemteX) | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner 11.41. The volume average particle size of the toner M1 thus obtained is shown in Table 2.

(Preparation of toner M2)

| | |
|---|---|
| Polyester resin A | 34.4 parts |
| Polyester resin B | 51.6 parts |
| Paraffin wax “HNP9” (trade name; product of Nippon: | 6.0 parts |
| Seiro, melting temperature 74° C.) | |
| Magenta pigment (C.I. Pigment Red 122, product of | 3.0 parts |
| Dainichiseika Color & Chemicals) | |
| Magenta pigment (C.I. Pigment Red 238, product of | 3.0 parts |
| Sanyo Color Works) | |
| Naphthalocyanine-based infrared absorbing material | 2.0 parts |
| (“YKR5010”, trade name; product of Yamamoto | |
| Chemicals) | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner M2. The volume average particle size of the toner M2 thus obtained is shown in Table 2.

### (Preparation of Toner M3)

In a similar manner to that employed in the preparation of the toner M1 except that 34.92 parts of the polyester resin A, 52.38 parts of the polyester resin. B, and 0.7 part of the aminium-based infrared absorbing material “NIR-AM1” were added, a toner M3 is obtained. The volume average particle size of the resulting toner M3 is shown in Table 2.

(Preparation of toner C1)

| | |
|---|---|
| Polyester resin A | 35.0 parts |
| Polyester resin B | 52.5 parts |
| Paraffin wax “HNP9” (trade name; product of Nippon | 6.0 parts |
| Seiro, melting temperature: 74° C.) | |
| Cyan pigment (C.I. Pigment Blue 15:3, product of | 5.0 parts |
| Dainichiseika Color & Chemicals) | |
| Aminium-based infrared absorbing material (“NIR-AM1”, | 1.5 parts |
| trade name; product of Nagase ChemteX | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner C1. The volume average particle size of the toner C1 thus obtained is shown in Table 2.

(Preparation of toner C2)

| | |
|---|---|
| Polyester resin A | 34.8 parts |
| Polyester resin B | 52.2 parts |
| Paraffin wax “HNP9” (trade name; product of Nippon | 6.0 parts |
| Seiro, melting temperature: 74° C.) | |
| Cyan pigment (C.I. Pigment Blue 15:3, product of | 5.0 parts |
| Dainichiseika Color & Chemicals) | |
| Diimonium-based infrared absorbing material (“NIR-IM1”, | 2.0 parts |
| trade name; product of Nagase ChemteX | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner C2. The volume average particle size of the toner C2 thus obtained is shown in Table 2.

(Preparation of toner C3)

In a similar manner to that employed in the preparation of the toner C1 except that 35.4 parts of the polyester resin A, 53.1 parts of the polyester resin B, and 0.5 part of the aminium-based infrared absorbing material “NIR-AM1” were added, a toner C3 is obtained. The volume average particle size of the resulting toner C3 is shown in Table 2.

(Preparation of toner K1)

| | |
|---|---|
| Polyester resin A | 33.6 parts |
| Polyester resin B | 50.4 parts |
| Paraffin wax “HNP9” (trade name; product of | 6.0 parts |
| Nippon Seiro, melting temperature: 74° C.) | |
| Carbon black (“#25”, trade name; product of | 10.0 parts |
| Mitsubishi Chemical) | |

The above components are mixed in powder form in a Henschel mixer, followed by heat kneading in a twin screw extruder (temperature set at 105° C.). After cooling, coarse grinding with a hammer mill, fine grinding with a jet mill, and classification with an air classifier are performed to obtain toner particles.

Then, with 100 parts of the resulting toner particles, 1.0 part of hydrophobic silica particles (“TG-820F”, trade name; product of Cabot Specialty Chemicals Inc) is mixed externally by using a Henschel mixer to obtain a toner K1. The volume average particle size of the toner K1 thus obtained is shown in Table 2.

(Preparation of toner Y4)

| | |
|---|---|
| Resin particle dispersion A | 1,190.0 parts |
| Resin particle dispersion B | 1,190.0 parts |
| Release agent dispersion | 300.0 parts |
| Coloring agent dispersion A | 20.0 parts |
| Additive dispersion A | 33.3 parts |

A round-shaped stainless steel flask is charged with the above-described materials according to the above-described composition and they are mixed and dispersed sufficiently by using a homogenizer (“Ultra-turrax T50”, trade name; product of IKA). A 1% aqueous solution of aluminum sulfate is added as a coagulant to the resulting dispersion and a dispersing operation with Ultra-turrax is continued.

A stirrer and a mantle heat are placed. While adjusting the rotation speed of the stirrer as needed so as to achieve sufficient stirring of the slurry, the temperature is raised to 45° C. at a temperature elevation rate of 0.5° C./min. After the reaction product is retained at 45° C. for 15 minutes, the particle size is measured using Coulter Counter [TA-II] (aperture diameter: 100 μm, product of Beckman Coulter) every 10 minutes while elevating the temperature at a rate of 0.05° C./min. When the volume average particle size reaches 7.6 μm, a mixture of 600 parts of the resin particle dispersion A and 600 parts of the resin particle dispersion B is charged as an additional resin over 3 minutes. After charging, the reaction mixture is retained for 30 minutes and is then adjusted to pH 8.0 with a 5 wt. % aqueous solution of sodium hydroxide to terminate the aggregation. Then, the temperature is elevated to 95° C. at a rate of 1° C./min and the reaction mixture is retained at 95° C. The particle shape and surface condition are observed using an optical microscope and a scanning electron microscope every 30 minutes. When the aggregated particles are fused sufficiently, they are cooled with ice water to immobilize the particles.

The reaction product is then filtered, washed sufficiently with ion exchanged water, and then dried using a vacuum drier to obtain a toner. With 100 parts of the resulting toner, 1 part of hydrophobic silica particles (“TG-820F”, trade name; product of Cabot Specialty Chemicals Inc.) is mixed externally by using a Henschel mixer to obtain a toner Y4. The volume average particle size of the resulting toner Y4 is shown in Table 2.

(Preparation of toner M4)

| | |
|---|---|
| Resin particle dispersion A | 1,150.0 parts |
| Resin particle dispersion B | 1,150.0 parts |
| Release agent dispersion | 300.0 parts |
| Coloring gent dispersion B | 15.0 parts |
| Coloring gent dispersion C | 15.0 parts |
| Additive dispersion A | 33.3 parts |

In a similar manner to that employed in the preparation of the toner Y4 except that a round-shaped stainless steel flask is charged with the above-described materials according to the above-described composition, a toner M4 is prepared. The volume average particle size of the toner M4 is shown in Table 2.

(Preparation of toner C4)

| | |
|---|---|
| Resin particle dispersion A | 1,170.0 parts |
| Resin particle dispersion B | 1,170.0 parts |
| Release agent dispersion | 300.0 parts |
| Coloring gent dispersion D | 217 parts |
| Additive dispersion A | 33.3 parts |

In a similar manner to that employed in the preparation of the toner Y4 except that a round-shaped stainless steel flask is charged with the above-described materials according to the above-described composition, a toner C4 is prepared. The volume average particle size of the toner C4 is shown in Table 2.

(Preparation of toner K2)

| | |
|---|---|
| Resin particle dispersion A | 1,220.0 parts |
| Resin particle dispersion B | 1,220.0 parts |
| Release agent dispersion | 300.0 parts |
| Coloring gent dispersion E | 15.0 parts |

In a similar manner to that employed in the preparation of the toner Y4 except that a round-shaped stainless steel flask is charged with the above-described materials according to the above-described composition, a toner K2 is prepared. The volume average particle size of the toner K2 is shown in Table 2.

TABLE 2

| Toner | Y1 | Y2 | Y3 | Y4 | M1 | M2 | M3 | M4 |
|---|---|---|---|---|---|---|---|---|
| Volume average particle size | 8.5 μm | 8.9 μm | 8.3 μm | 8.5 μm | 8.3 μm | 8.5 μm | 8.6 μm | 8.1 μm |

| Toner | C1 | C2 | C3 | C4 | K1 | K2 |
|---|---|---|---|---|---|---|
| Volume average particle size | 8.4 μm | 8.1 μm | 8.5 μm | 8.1 μm | 8.7 μm | 8.2 μm |

### (Preparation of Carrier and Developer)

A carrier is obtained by coating 100 parts of Mn ferrite particles (“MF-60”, trade name; product of Powdertech) having a particle size of 60 μm with 1.5 parts of a dimethyl silicone resin (“SR2410”, trade name; product of Dow Corning Toray).

A combination of a carrier and a toner as shown in Table 3 is charged in a V-shaped blender and mixed at 40 rpm for 20 minutes to obtain developers Y1 to K2.

TABLE 3

| | Developer | Developer | Developer | Developer | Developer | Developer | Developer | Developer |
|---|---|---|---|---|---|---|---|---|
| | Y1 | Y2 | Y3 | Y4 | M1 | M2 | M3 | M4 |
| Carrier | 94 parts | 94 parts | 94 parts | 94 parts | 95 parts | 95 parts | 95 parts | 95 parts |
| Toner | Toner Y1 | Toner Y2 | Toner Y3 | Toner Y4 | Toner M1 | Toner M2 | Toner M3 | Toner M4 |
| | 6 parts | 6 parts | 6 parts | 6 parts | 5 parts | 5 parts | 5 parts | 5 parts |

| | Developer | Developer | Developer | Developer | Developer | Developer |
|---|---|---|---|---|---|---|
| | C1 | C2 | C3 | C4 | K1 | K2 |
| Carrier | 94 parts | 94 parts | 94 parts | 94 parts | 94.5 parts | 94.5 parts |
| Toner | Toner C1 | Toner C2 | Toner C3 | Toner C4 | Toner K1 | Toner K2 |
| | 6 parts | 6 parts | 6 parts | 6 parts | 5.5 parts | 5.5 parts |

### (Evaluation)

A combination of developers according to Table 4 is evaluated. Evaluation is performed using a remodeled machine of “490/980 Color Continuous Feed Printing Systems” (trade name; product of Fuji Xerox). Under the conditions of 20° C. and 50% RH, a chart including halftone images (image density (Cin)=10%, 20%, and 50%) and solid images of respective colors is output to an A2 200-m roll of high-quality paper (E) (product of Fuji Xerox) processed into a 12,000-m roll. At this time, a standard fixing device is deactivated and an unfixed sample is collected. Image fixing of the unfixed sample is performed using the below-described fixing device and the fixing property is evaluated.

### —Fixing Device A—: Flash Fixing Device

Fixing is performed using a fixing bench obtained by remodeling a fixing device “DocuPrint 1100CF” (trade name; product of Fuji Xerox) to enable single operation. An irradiation energy upon fixing is 3.0 J/cm² and under some conditions, additional evaluation at 4.0 J/cm² is performed.

### —Fixing Device B—: Laser Fixing Device

Five semiconductor laser (center wavelength: 808 nm) oscillators (product of Coherent Japan) are arranged in an array and the array is stacked one after another. A linear beam is formed using a collimation lens. The evaluation is performed after adjusting the output to give an irradiation energy of 1.0 J/cm² on an irradiated area. Under some conditions, additional evaluation at 1.5 J/cm² is performed.

The fixing device A or B is used at a process speed of 1,100 mm/sec.

The fixing property is evaluated by a fixing rate in a tape peel test. The tape peel test is performed by lightly attaching an adhesion tape (“Scotch Mending Tape”, trade name; product of 3M) on a fixed image, turning a columnar block in a circumferential direction to firmly adhere the tape to the image surface at a linear pressure of 250 g/cm, and then peeling the tape from the image. An optical density ratio between the image before and after peeling of the tape, which is represented by the following equation, is defined as a fixing ratio.

Fixing ratio(%)=(image density after peeling of the tape)/(image density before adhesion of the tape)×100

The optical density of the fixed image of each color is measured using “X-RITE938” (trade name, product of X-rite) and judgment is made based on the following criteria.

Level 4: fixing rate≧95%, satisfactory level without loss of image/dot

Level 3: 95%>fixing rate≧85%, no problem in practical use, though missing of dots is slightly observed.

Level 2: 85%>fixing rate≧75%, missing of dots is observed, and contamination on the backside appears upon stacking.

Level 1: 75%>fixing rate, missing of most of dots is observed and fingers are stained when they touch the image

With respect to only the solid image, appearance of voids is checked through the observation of an image surface with an optical microscope (×100). The results are shown in the column of “void appearance” in Table 4. The image is ranked as A when no void appears and ranked as B when voids appear.

TABLE 4

| Ex. and | | Irradiation | | | | Fixing rate | | | | | | | | |
|---|---|---|---|---|---|---|---|---|---|---|---|---|---|---|
| Comp. | Fixing | energy | Developer | Absorption | Absorption | Cin = | | Cin = | | Cin = | | | | Appearance |
| Ex. (C) | device | (J/cm²) | (toner) | rate α | ratio Δα | 10% | | 20% | | 50% | | Solid | | of void |
| 1 | Flash | 3.5 | Y1 | 0.811 | 0.098 | 85% | 3 | 86% | 3 | 93% | 3 | 93% | 3 | A |
| | | | M1 | 0.814 | | 88% | 3 | 90% | 3 | 94% | 3 | 94% | 3 | A |
| | | | C1 | 0.849 | | 90% | 3 | 92% | 3 | 95% | 4 | 98% | 4 | A |
| | | | K1 | 0.909 | | 98% | 4 | 98% | 4 | 100% | 4 | 100% | 4 | A |
| 2 | Flash | 3.5 | Y2 | 0.829 | 0.076 | 88% | 3 | 89% | 3 | 95% | 4 | 96% | 4 | A |
| | | | M2 | 0.825 | | 88% | 3 | 92% | 3 | 96% | 4 | 95% | 4 | A |
| | | | C2 | 0.889 | | 92% | 3 | 96% | 4 | 98% | 4 | 99% | 4 | A |
| | | | K2 | 0.901 | | 97% | 4 | 98% | 4 | 100% | 4 | 100% | 4 | A |
| 3 | Laser | 1 | Y2 | 0.792 | 0.099 | 85% | 3 | 89% | 3 | 95% | 4 | 96% | 4 | A |
| | | | M2 | 0.891 | | 93% | 3 | 96% | 4 | 99% | 4 | 98% | 4 | A |
| | | | C2 | 0.832 | | 88% | 3 | 93% | 3 | 100% | 4 | 100% | 4 | A |
| | | | K2 | 0.89 | | 93% | 3 | 96% | 4 | 100% | 4 | 100% | 4 | A |
| 4 | Laser | 1 | Y4 | 0.889 | 0.026 | 95% | 4 | 98% | 4 | 99% | 4 | 100% | 4 | A |
| | | | M4 | 0.88 | | 96% | 4 | 99% | 4 | 100% | 4 | 100% | 4 | A |
| | | | C4 | 0.888 | | 96% | 4 | 99% | 4 | 100% | 4 | 100% | 4 | A |
| | | | K1 | 0.906 | | 98% | 4 | 100% | 4 | 100% | 4 | 100% | 4 | A |
| C1 | Flash | 3.5 | Y3 | 0.785 | 0.116 | 69% | 1 | 83% | 2 | 93% | 3 | 94% | 3 | A |
| | | | M2 | 0.825 | | 88% | 3 | 82% | 3 | 97% | 4 | 96% | 4 | A |
| | | | C2 | 0.889 | | 92% | 3 | 85% | 4 | 98% | 4 | 100% | 4 | A |
| | | | K2 | 0.901 | | 97% | 4 | 99% | 4 | 100% | 4 | 100% | 4 | A |
| C2 | Flash | 3.5 | Y3 | 0.785 | 0.168 | 71% | 1 | 82% | 2 | 94% | 3 | 95% | 4 | A |
| | | | M3 | 0.748 | | 69% | 1 | 81% | 2 | 96% | 4 | 97% | 4 | A |
| | | | C3 | 0.741 | | 73% | 1 | 82% | 2 | 93% | 3 | 95% | 4 | A |
| | | | K1 | 0.909 | | 98% | 4 | 99% | 4 | 100% | 4 | 100% | 4 | A |
| C3 | Laser | 1 | Y4 | 0.889 | 0.131 | 95% | 4 | 97% | 4 | 99% | 4 | 99% | 4 | A |
| | | | M1 | 0.775 | | 72% | 1 | 83% | 2 | 89% | 3 | 95% | 4 | A |
| | | | C4 | 0.888 | | 97% | 4 | 98% | 4 | 99% | 4 | 100% | 4 | A |
| | | | K1 | 0.906 | | 98% | 4 | 99% | 4 | 100% | 4 | 100% | 4 | A |
| C4 | Flash | 4.5 | Y3 | 0.785 | 0.116 | 88% | 3 | 93% | 3 | 98% | 4 | 99% | 4 | A |
| | | | M2 | 0.838 | | 93% | 3 | 96% | 4 | 99% | 4 | 100% | 4 | A |
| | | | C2 | 0.889 | | 95% | 4 | 98% | 4 | 100% | 4 | 100% | 4 | A |
| | | | K2 | 0.901 | | 99% | 4 | 99% | 4 | 100% | 4 | 83% | 2 | B |
| C5 | Flash | 4.5 | Y3 | 0.785 | 0.168 | 88% | 3 | 92% | 3 | 95% | 4 | 99% | 4 | A |
| | | | M3 | 0.748 | | 86% | 3 | 95% | 4 | 98% | 4 | 100% | 4 | A |
| | | | C3 | 0.741 | | 86% | 3 | 95% | 4 | 99% | 4 | 100% | 4 | A |
| | | | K1 | 0.909 | | 99% | 4 | 100% | 4 | 100% | 4 | 81% | 2 | B |
| C6 | Flash | 1.5 | Y4 | 0.889 | 0.131 | 97% | 4 | 99% | 4 | 99% | 4 | 100% | 4 | A |
| | | | M1 | 0.775 | | 89% | 3 | 92% | 3 | 95% | 4 | 99% | 4 | A |
| | | | C4 | 0.888 | | 99% | 4 | 99% | 4 | 100% | 4 | 92% | 3 | B |
| | | | K1 | 0.906 | | 99% | 4 | 100% | 4 | 100% | 4 | 73% | 1 | B |

It is apparent from the above-described evaluation results that both the solid images and halftone images obtained in Examples 1 to 4 are superior to those obtained in Comparative Examples C1 to C6 in fixing property.

The flash irradiation energy of Comparative Example 4 (C4) is made greater than that of Comparative Example 1 (C1). An increase in the irradiation energy improves the fixing property of the halftone image, but voids appear markedly in the solid image, especially in the black toner, suggesting that it is difficult to satisfy fixing properties in both solid and halftone images.

The flash irradiation energy of Comparative Example 5 (C5) is made greater than that of Comparative Example 2 (C2). Voids also appear markedly in the solid image.

The laser irradiation energy of Comparative Example 6 (C6) is made greater than that of Comparative Example 3 (C3) and similarly, voids appear markedly in the solid image.

What is claimed is:

1. An electrostatic image developing toner set comprising two or more toners different in hue,
wherein a difference between maximum and minimum values of an absorption rate α in a range of from 380 nm to 1,500 nm of each of the two or more toners is about 0.1 or less, the absorption rate α being represented by the following equation (1):
$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$
wherein
e_{λ} represents an emission intensity of a light source at a wavelength λ, and
A_{λ} represents an absorbance of a toner at a wavelength λ.

2. The electrostatic image developing toner set according to claim 1, wherein
the two or more toners comprises one or more color toners, and
the absorption rate α of each of the one or more color toners is about 0.7 or greater.

3. The electrostatic image developing toner set according to claim 2, wherein
each of the two or more toners contains a coloring agent and a binder resin, and
a content of the coloring agent is from about 1 part by weight to about 30 parts by weight based on 100 parts by weight of the binder resin.

4. The electrostatic charge developing toner according to claim 2, wherein
the coloring agent contains at least one of C.I. Pigment Red 48:1, C.I. Pigment Red 122, C.I. Pigment Red 57:1, C.I. Pigment Yellow 97, C.I. Pigment Yellow 17, C.I. Pigment Blue 15:1, and C.I. Pigment Blue 15:3.

5. The electrostatic latent image developing toner set according to claim 1, wherein
each of the two or more toners contains a release agent, and
a content of the release agent is about 50 parts by weight or less based on 100 parts by weight of the toner.

6. The electrostatic latent image developing toner set according to claim 2, wherein
each of the one or more color toners contains an infrared absorbing material.

7. The electrostatic latent image developing toner set according to claim 6, wherein
the infrared absorbing material contains at least one of an aminium-based infrared absorbing material, a naphthalocyanine-based infrared absorbing material, and a diimmonium-based infrared absorbing material.

8. The electrostatic latent image developing toner set according to claim. 1, which is used for a non-contact fixing system.

9. The electrostatic latent image developing toner set according to claim 1, wherein
the two or more toners comprises at least a black toner.

10. The electrostatic latent image developing toner set according to claim 9, wherein
the two or more toners further comprises one or more color toners, and
the absorption rate α of each of the one or more color toners is about 0.7 or greater.

11. The electrostatic image developing toner set according to claim 10, wherein
each of the two or more toners contains a coloring agent and a binder resin, and
a content of the coloring agent is from about 1 part by weight to about 30 parts by weight based on 100 parts by weight of the binder resin.

12. The electrostatic charge developing toner according to claim 10, wherein
the coloring agent contains at least one of C.I. Pigment Red 48:1, C.I. Pigment Red 122, C.I. Pigment Red 57:1, C.I. Pigment Yellow 97, C.I. Pigment Yellow 17, C.I. Pigment Blue 15:1, and C.I. Pigment Blue 15:3.

13. The electrostatic latent image developing toner set according to claim 9, wherein
each of the two or more toners contains a release agent, and
a content of the release agent is about 50 parts by weight or less based on 100 parts by weight of the toner.

14. The electrostatic latent image developing toner set according to claim 10, wherein
each of the one or more color toners contains an infrared absorbing material.

15. The electrostatic latent image developing toner set according to claim 14, wherein
the infrared absorbing material contains at least one of an aminium-based infrared absorbing material, a naphthalocyanine-based infrared absorbing material, and a diimmonium-based infrared absorbing material.

16. The electrostatic latent image developing toner set according to claim 9, which is used for a non-contact fixing system.

17. An image forming method comprising:
preparing a toner set which contains two or more toners different in hue, wherein a difference between maximum and minimum values of an absorption rate α in a range of from 380 nm to 1,500 nm of each of the toners is about 0.1 or less, the absorption rate α being represented by the following equation (1);
forming a toner image with the two or more toners different in hue; and
fixing the toner image by a non-contact fixing system,
$$Absorption rate α = \{ {\sum }_{λ = 380}^{1500} {e}_{λ} ( 1 - \frac{1}{{10}^{{A}_{λ}}} ) \} / \{ {\sum }_{λ = 380}^{1500} {e}_{λ} \} \qquad ( 1 )$$
wherein
e_{λ} represents an emission intensity of a light source at a wavelength λ, and
A_{λ} represents an absorbance of a toner at a wavelength λ.

18. The image forming method according to claim 17, wherein
the two or more toners comprises one or more color toners, and
the absorption rate α of each of the one or more color toners is about 0.7 or greater.

19. The image forming method according to claim 17, wherein
the fixing of the toner image by a non-contact fixing system is performed by flash exposure with a xenon lamp or scanning exposure with a semiconductor laser.

20. The image forming method according to claim 17, wherein
a process speed thereof is about 1,000 mm/sec or greater.
